(19) United States
(12) Patent Application Publication
(10) Pub. No.: US 2025/0264181 A1
(43) Pub. Date: Aug. 21, 2025

(54) MODULAR SADDLE FOR PIPE CLAMP

(71) Applicant: Louis J George, New Lenox, IL (US)

(72) Inventor: Louis J George, New Lenox, IL (US)

(21) Appl. No.: 18/443,024

(22) Filed: Feb. 15, 2024

(51) Int. Cl. F16L 55/17

(52) U.S. Cl. CPC F16L 55/1705

(57) ABSTRACT

A clamp saddle for attachment to a pipe clamp that allows the clamp to be used for plugging leaks in different diameters of pipe is disclosed. The clamp saddle includes a semi-circular main body that is conformed to a specific pipe diameter. An attachment mechanism on the main body that interchangeably connects to an arm of a clamp. A different diameter clamp saddle may replace the initial saddle to allow the clamp to be used for a different diameter pipe.

### TECHNICAL FIELD

The present disclosure relates generally to a saddle device for pipe clamp. More particularly, aspects of this disclosure relate to a modular saddle allowing adaptable use of a clamp for pipe leaks on different diameter pipes.

### BACKGROUND

Pipes are well known conduits for liquids or gasses. One well-known problem is when a pipe begins to leak liquids or gasses through a pinhole sized rupture. Emergency pipe repairs are necessitated by such leaks in a pipe. It is desirable that a temporary repair be made that plugs the leak to allow the pipe to continue to function. On discovery of the leak location, a user will typically apply a covering over the area of pipe where the leak occurs. The covering then requires a clamp that seals the leak by applying pressure to the covering. This allows flow to continue through the pipe without leaking out of the pinhole. The short term covering material held in place with the clamp allows the pipe to continue functioning until a more permanent repair such as replacing the pipe may be scheduled.

The problem with current clamping techniques is that they require tools such as channel locks, sockets, crescent wrenches, and open end wrenches to be employed. Further, clamps must be adapted to match the covering materials and specific diameter pipes. Such adaptations are sometimes ineffective in plugging leaks. Current methods require tools for the installation of the clamp. Such tools are cumbersome and require both hands for installation.

Thus, there is a need for a device that allows any type of clamp to be used in conjunction with preventing pipe leaks. There is another need for a clamp saddle that has sufficient adhesion to a pipe to prevent a pipe leak.

### SUMMARY

One disclosed example is clamp saddle for attachment to a pipe clamp. The clamp saddle has a semi-circular main body that is conformed to a specific pipe diameter. An attachment mechanism on the main body interchangeably connects to an arm of a clamp.

A further implementation of the example clamp saddle is where the clamp is one of the group consisting of a C-clamp, a plier clamp, a twist clamp, or a hand clamp. Another implementation is where the clamp further has another arm that may be connected to another saddle. Another implementation is where the example clamp saddle includes an interior surface layer fabricated from one of nitrile rubber, silicone rubber, or neoprene rubber that engages the pipe surface. Another implementation is where the interior surface layer is attached to the interior surface of the saddle via an adhesive. Another implementation is where the clamp saddle is fabricated from aluminum or steel. Another implementation is where the pipe diameter is one of 0.5 inch, 0.75 inch, 1 inch, 1.25 inches, 1.5 inches, 2 inches, 2.5 inches, 3 inches, or 4 inches. Another implementation is where the pipe is one of plastic pipe, steel pipe, or copper pipe. Another implementation is where the attachment mechanism is a pin mechanism, and wherein the saddle includes brackets with a hole aligned to a hole on the arm of the clamp, where a shaft of the pin mechanism is inserted in the holes.

Another disclosed example is a clamp for plugging a pipe leak. The clamp includes a first arm having a first end and a second arm having a second end. A first saddle includes a semi- semi-circular main body that is conformed to a specific pipe diameter. The first saddle includes an attachment mechanism on the main body that attaches to the first end of the first arm. A second saddle has a semi-circular main body that is conformed to the specific pipe diameter. The second saddle has an attachment mechanism on the main body that attaches to the second end of the second arm.

A further implementation of the example clamp is where the clamp is one of the group consisting of a C-clamp, a plier clamp, a twist clamp, or a hand clamp. Another implementation is where the first and second saddles each include an interior surface layer fabricated from one of nitrile rubber, silicone rubber, or neoprene rubber that engages the pipe surface. Another implementation is where the interior surface layer is attached to the interior surface of the respective first and second saddles via an adhesive. Another implementation is where the first and second saddle are fabricated from aluminum or steel. Another implementation is where the pipe diameter is one of 0.5 inch, 0.75 inch, 1 inch, 1.25 inches, 1.5 inches, 2 inches, 2.5 inches, 3 inches, or 4 inches. Another implementation is where the pipe is one of plastic pipe, steel pipe, or copper pipe. Another implementation is where the attachment mechanism of the first and second saddles is a pin mechanism. The first and second saddles each include brackets with a hole aligned to a hole on the respective first and second arms. The pin mechanisms include a respective shaft that may be inserted in the holes.

Another disclosed example is a kit for patching pipes of different diameters. The kit has a first set of saddles. Each of the saddles include a semi-circular main body that is conformed to a specific first pipe diameter. Each of the saddles of the first set have an attachment mechanism on the main body attaches to an end of an arm of a clamp. The kit has a second set of saddles. Each of the saddles of the second set include a semi-circular main body that is conformed to a specific second pipe diameter. The second set of saddles also each include an attachment mechanism on the main body that attaches to the end of the arm of the clamp.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure will be better understood from the following description of exemplary embodiments together with reference to the accompanying drawings, in which:

FIG. 1A is a perspective view of a C-clamp locking plier and an example set of saddles for stopping leaks in a pipe;

FIG. 1B is a perspective view of the C-clamp locking plier in FIG. 1A that is locked in a closed position with the saddles plugging a leak in the pipe;

FIG. 1C is a reverse perspective view of the C-clamp locking plier in FIG. 1A that is locked in the closed position;

FIG. 2 is a close up perspective view of an example saddle in FIGS. 1A-1B that may be attached to different types of clamps;

FIG. 3 is an exploded perspective view of the components of the clamp and saddles in FIG. 1;

FIG. 4A is a close-up exploded perspective view of the saddle, the pin and one of the arms of the clamp in FIG. 1;

FIG. 4B is a close-up perspective view showing the saddle aligned with the arms of the clamp;

FIG. 4C is a close-up perspective view showing the pin mechanism being inserted to attach the saddle to the clamp arm;

FIG. 4D is a close-up perspective view showing the pin mechanism being fully inserted;

FIG. 5 shows a set of alternative pin mechanisms that may be used to join the example saddle to a clamp arm;

FIG. 6A is a perspective view of the C-clamp locking plier in FIG. 1A fitted with different diameter saddles to plug a leak in a different diameter pipe;

FIG. 6B is a perspective view of the C-clamp locking plier in FIG. 1A fitted with a second set of different diameter saddles to plug a leak in a second different diameter pipe;

FIGS. 7A-7B are perspective views of a twist type clamp with example saddles of different diameters to plug leaks in different diameter pipes;

FIG. 8 is a C-clamp fitted with the example saddles to plug leaks in a pipe; and

FIG. 9 is a hand clamp fitted with the example saddles to plug leaks in a pipe.

The present disclosure is susceptible to various modifications and alternative forms, and some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION OF THE ILLUSTRATED EMBODIMENTS

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at, near, or nearly at,” or “within 3-5% of,” or “within acceptable manufacturing tolerances,” or any logical combination thereof, for example.

The present disclosure relates to an emergency pipe repair tool system that may be adapted to different diameters of pipes and use different types of clamps. The pipe repair tool system includes saddles that may be interchangeably attached to the arms of a clamp to cover an area of a pipe with a leak. The clamp may then be locked in place by the clamp to provide pressure to the saddles. The example saddles clamp down on the pipe in order to create a temporary repair to pinhole leaks in the pipe. The example saddles include a resilient member that allows a better seal with the pipe to plug such leaks. The example saddle also includes an attachment mechanism that allows easy modular attachment and removal from different types of clamps. Thus, one clamp may be used with different diameter pipes by simply interchangeably attaching saddles having a diameter that matches the pipe diameter.

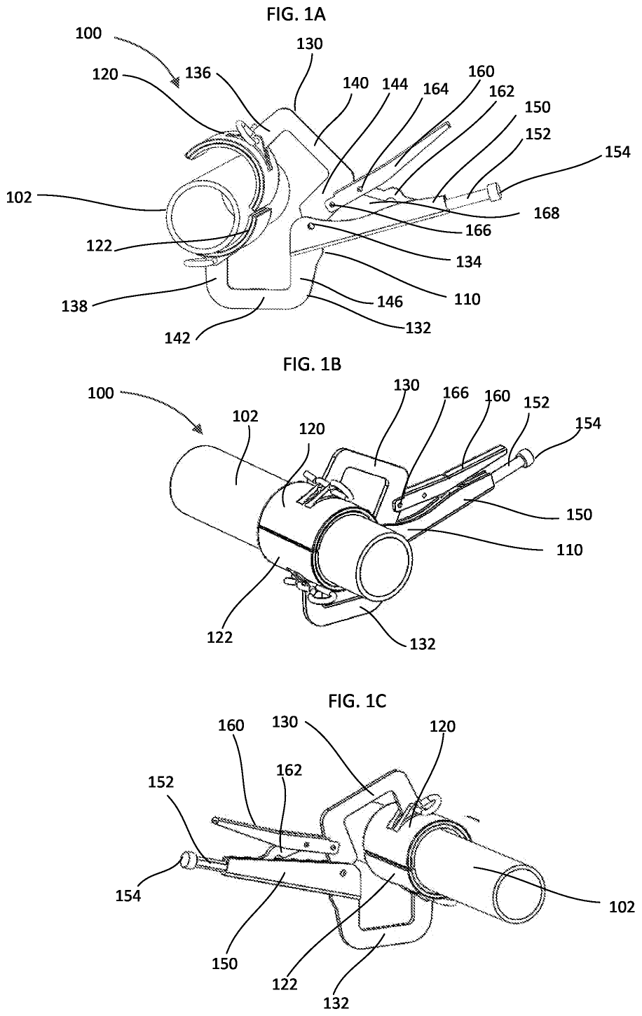

FIG. 1A shows an example tool system 100 is used to temporarily plug a leak in a pipe 102. In this example, the pipe 102 is a 2 inch diameter pipe. The tool system 100 includes a clamp 110 fitted with example interchangeable saddles 120 and 122. In this example, the saddles 120 and 122 have a semi-circular shape that matches the 1.25 inch of diameter of the pipe 102. As will be explained, different diameter saddles may be selected for the use of the clamp for plugging leaks in different diameter pipes by interchanging the saddles 120 and 122 with saddles of different diameters. The saddles 120 and 122 may also be interchanged with each other. In this example, the clamp 110 is a C-clamp locking plier clamp having an upper arm 130 and a lower arm 132. The arms 130 and 132 are generally C-shaped and rotatably coupled via a pin 134 that allows the rotation of the arms 130 and 132 relative to each other. The arms 130 and 132 have corresponding mandible members 136 and 138. As will be explained the saddles 120 and 122 may be interchangably attached and removed on connector mechanisms on the ends of the mandibles 136 and 138. The arms 130 and 132 have corresponding opposite actuator members 140 and 142 that are joined to the respective mandibles 136 and 138 via connector members 144 and 146.

A handle member 150 is rotatably attached to the pin 134. The handle member 150 has a threaded interior surface that holds a drive shaft 152. One of the drive shaft 152 moves linearly within the handle member 150 when the drive shaft 152 is rotated. The opposite end of the shaft 152 is connected to a dial 154 that allows a user to rotate the shaft 152. A lever 160 is rotatably attached to an actuator member 162. One end of the actuator member 162 is attached to the end of the shaft 152 in the handle member 150. The opposite end of the actuator member 162 is rotatably attached to the lever 160 via a pin 164 that is located in the middle of the lever 160. Another pin 166 rotatably attaches the lever 160 to the support 144 of the upper arm 130. The rotation of the shaft 152 allows the transversal of the actuator member 162 along the length of the handle member 150. A spring 168 is attached between the handle member 150 and the lever 160 to prevent the lever 160 to be fully rotated to contact the handle member 150. The movement of the actuator member 162 either moves the lever 160 to close the arm 130 or open the arm 132. Thus, when a user rotates the dial 154 clockwise, the rotation of the shaft 152 pushes the actuator member 162 toward the pivot 134. The movement of the actuator member 162 causes the lever 160 to rotate counter-clockwise around the pin 166, thus moving the arm 130 toward the other arm 132. This creates pressure on the pipe 102 between the saddles 120 and 122 and thus creates the seal to prevent leaks.

FIG. 1B is a perspective view of the clamp 110 engaged with the pipe 102. FIG. 1C is a reverse perspective view of the clamp 110 engaged with the pipe 102. As shown in FIGS. 1B-1C, a user can fully actuate the arms 130 and 132 by rotating the shaft 152 to allow the saddles 120 and 122 to grip the pipe 102. As the shaft 152 is rotated clockwise, more pressure on the pipe 102 is applied by the saddles 120 and 122. When force is applied to the saddles 120 and 122 via the arms 130 and 132, the saddles 120 and 122 cover leaks in the area of the pipe as shown in FIGS. 1B-1C. The pressure from the clamp 110 thus prevents liquid or gasses flowing through the pipe 102 from leaking. The shaft 152 is fixed in place in the handle member 150 and thus consistent pressure is applied through the arms 130 and 132 to plug the leak in the pipe 102. Additional coils with appropriate tightening devices may be applied around the saddles 120 and 122 to add additional pressure to plug the leak. The clamp 110 thus may be left on the pipe 102 for a relatively long period of time to allow the pipe 102 to function without leaking. Alternatively, with other attachment mechanisms such as coils applied to join the saddles 120 and 122, the clamp 110 may be detached from the saddles 120 and 122 and other saddles may be attached for using the clamp 110 for another pipe.

As explained above, rotation of the dial 154 moves the connection ends 136 and 138 of the arms 130 and 132 toward each other providing pressure on the saddles 120 and 122 to hold the pipe 102 as shown in FIG. 1B. When the dial 154 is twisted in a counter-clockwise direction, the actuator member 162 is pulled away from the pivot point 134. This causes the lever 160 to rotate in a clockwise direction around the pin 166, which pulls the arm 130 away from the arm 132. The respective mandibles 136 and 138 are thus moved away from each other, thus releasing the saddles 120 and 122 from the pipe 102. This allows the clamp 110 to be removed from the pipe 102 for a more permanent repair of the leak.

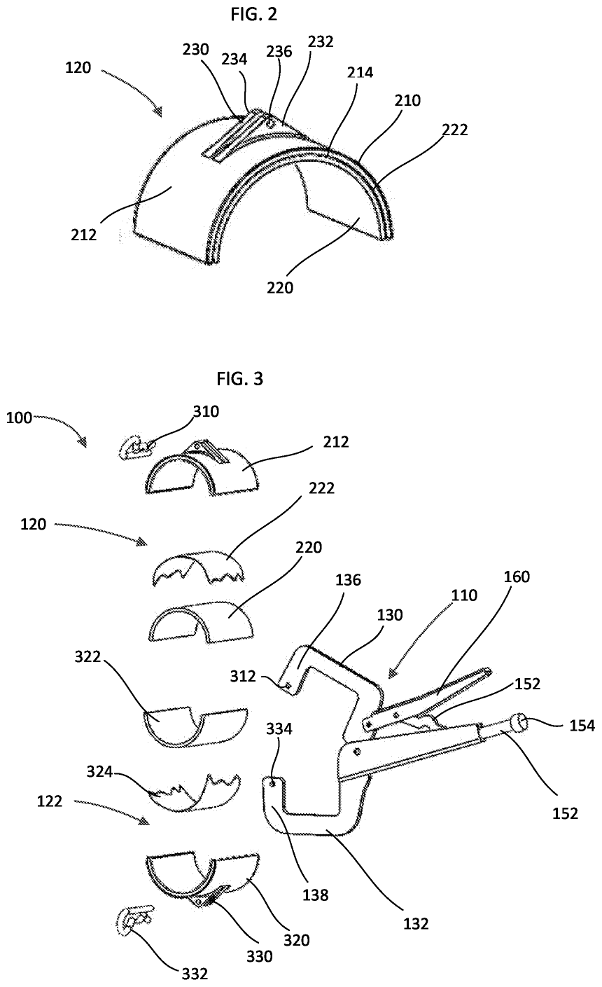

FIG. 2 is a close up perspective view of the saddle 120. The saddle 120 is a modular component that may be attached and detached to different types of clamps such as the clamp 110. The saddle 120 includes a main semi-circular body 210 of sufficient thickness to withstand a certain amount of pressure to contain pipe leaks. In this example, the semi-circular body 210 may be fabricated from a high strength material such as die cast 319 aluminum or steel. The diameter of the semi-circular body 210 may be selected to match the diameter of known common pipe diameters. Thus, any diameter pipe may be plugged using a clamp and by selecting the appropriate saddle having the matching diameter to the pipe. Thus, common pipe diameters such as 1¼″, 1½″, 2″, 2½″, 3″ and 4″ for plastic pipes, and ½″, ¾″ and 1″diameters for copper pipes may have saddles of corresponding diameters in the form of a patch kit.

The semi-circular body 210 has an exterior surface 212 and an interior surface 214. A resilient interior layer 220 is attached to the interior surface 214 via an adhesive layer 222. In this example, the resilient layer 220 is nitrile rubber, silicone rubber, or neoprene rubber sheeting. In this example, the resilient interior layer 220 is attached to the interior surface 214 via a self adhesive backing on the interior layer 220 or an applied adhesive such as Pliobond 25 brush on adhesive. The resilient interior layer 220 is compressed by the force applied to the clamp 120 to assist in sealing off the leak.

The exterior surface 212 includes parallel brackets 230 and 232. Each of the brackets 230 and 232 include respective holes 234 and 236 that allow a pin mechanism to be used to attach the saddle 120 to a clamp arm such as the clamp arm 130 in FIG. 1A. Thus, the brackets 230 and 232 form an attachment mechanism of the saddle 120. Of course other attachment mechanisms may be used such as nuts and bolts or any other suitable attachment devices.

FIG. 3 is an exploded perspective view of the components of the saddles 120 and 122 in relation to the clamp 110. A pin mechanism 310 is used to attach the saddle 120 to the mandible 136 of the arm 130. The mandible 136 has a hole 312. The hole 312 is aligned with the holes 134 and 136 of the brackets 130 and 132. The pin mechanism 310 is then inserted and locks the saddle 120 to the mandible 136. As shown in FIG. 3, the saddle 122 is identical to the saddle 120 and includes a semi-circular main body 320, a resilient interior layer 322 and an adhesive layer 324. The saddle 122 also includes an attachment mechanism 330 having parallel brackets for a pin mechanism 332. The mandible 138 of the bottom arm 132 includes a hole 334 for the insertion of the pin mechanism 332 to hold the saddle 122.

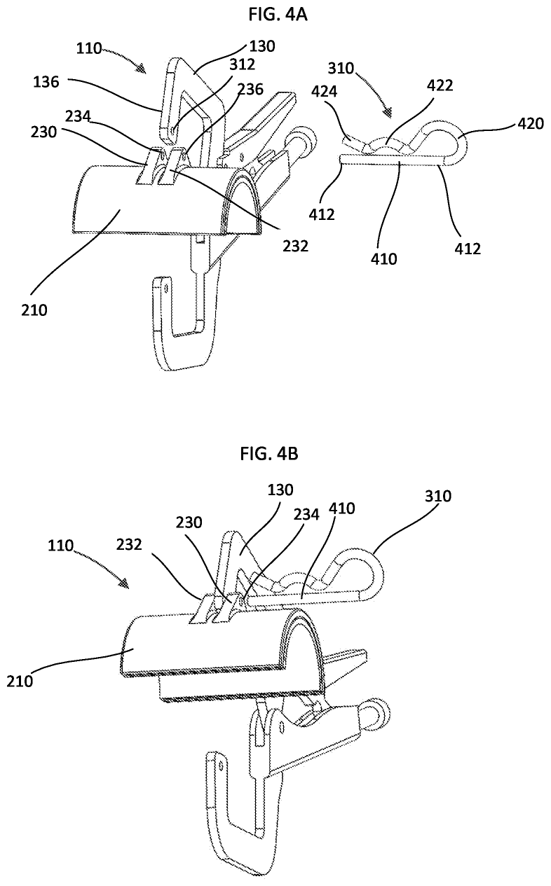

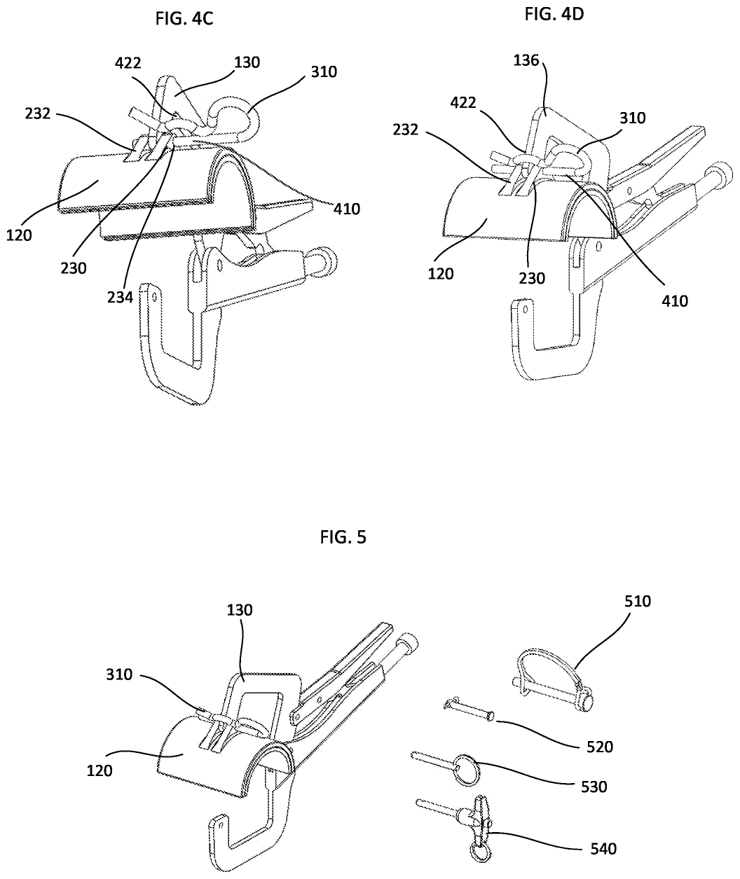

FIG. 4A is a close up exploded perspective view of the saddle 120, the mandible 136, and the pin mechanism 332. As may be seen, the parallel brackets 230 and 232 are triangular shaped with the respective holes 234 and 236 in lateral alignment. The parallel brackets 230 and 232 are spaced apart sufficiently to accommodate the mandible 136 of the clamp arm 130.

The pin mechanism 310 is a hitch pin clip. The pin mechanism 310 has a lateral shaft 410. The shaft 410 has a free end 412 and an opposite end 414 that is connected to a curved section 420. The section 420 includes a crimped section 422 and a free end 424. The pin mechanism 310 is fabricated from a high strength metal such as steel.

FIG. 4B shows the first step in attaching a saddle such as the saddle 120 to the clamp arm 130. The mandible 136 includes the hole 312. The saddle 120 is moved in position so the end of mandible 136 is positioned between the brackets 230 and 232. The saddle 120 is positioned so the holes 234 and 236 of the brackets 230 and 232 are aligned with the hole 312 as shown in FIG. 4B. The end 412 of the shaft 410 of the pin mechanism 310 is aligned with the hole 236 of the bracket 232.

The end 412 is inserted in the hole 234 of the bracket 230 and the shaft 410 is inserted through the holes 234, 312 and 236 as shown in FIG. 4C. The shaft 410 thus joins the saddle 120 to the mandible 136. The crimp section 422 is moved around the end of the mandible 136.

FIG. 4D shows the pin mechanism 310 fully inserted and thus connecting the saddle 120 to the mandible 136. The shaft 410 has been fully inserted and rests in the holes 232, 312, and 326 thus joining the mandible 136 to the brackets 230 and 232. The crimp section 422 rests on the edge of the mandible 136 to hold the pin mechanism 310 in place.

FIG. 5 shows a series of alternate pin mechanism that may be used for the pin mechanism 310. Thus, any suitable pin mechanism that has a shaft that can be inserted in the holes in the brackets of the saddle and the mandible of the clamp may be used. For example, pin mechanism 510, which is a Hillman Round Lock pin clip may be used. Another type of pin 520, which is a Clevis pin may be used. Still another pin mechanism 530, which is a quick release pin may be used. Still another pin mechanism 540, which is a quick release pin with handle may be used.

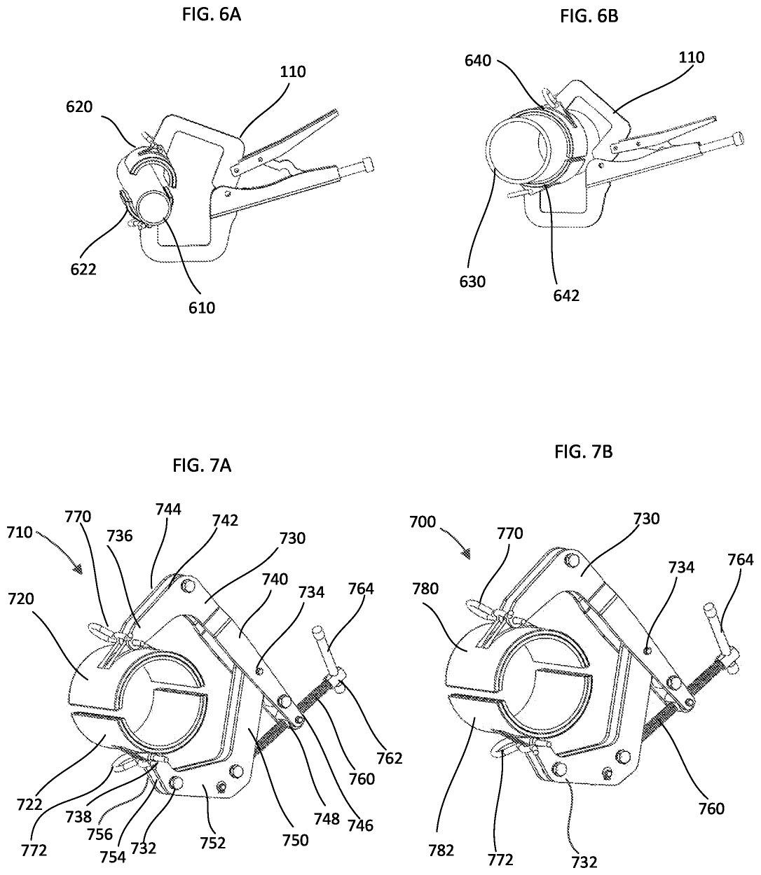

The example saddles such as the saddle 120 may be adapted for different diameter pipes. Thus, the clamp 110 may be used by interchanging the saddles 120 and 122 with different diameter saddles for a different diameter pipe. FIG. 6A shows the clamp 110 in FIG. 1A used to plug a leak in a 1.25 inch pipe 610. In this example, saddles 620 and 622 are attached to the mandibles 136 and 138 of the clamp 110. The saddles 620 and 622 have matching diameters to allow a fit with the 1.25 inch diameter pipe 610. Thus, exchanging the saddles 120 and 122 in FIG. 1A that are used for 2 inch pipe with the saddles 620 and 622 allow the clamp 110 to be used with a smaller diameter pipe such as the 1.25 inch pipe 610. The same pin mechanisms may be used to attach the saddles 620 and 622 to the clamp arms 130 and 132.

FIG. 6B shows the clamp 110 in FIG. 1A used to plug a leak in a 3 inch pipe 630. In this example, saddles 640 and 642 are attached to the mandibles 136 and 138 of the clamp 110. The saddles 640 and 642 have matching diameters to allow a fit with the 3 inch diameter pipe 630. Thus, exchanging the saddles 120 and 122 in FIG. 1A that are used for 2 inch pipe with the saddles 640 and 642 allow the clamp 110 to be used with a larger diameter pipe such as the 3 inch pipe 630.

The example saddles may be adapted for use with different types of clamps. FIG. 7A is a perspective view of a twist type clamp 710 that may be used in conjunction with the example saddles to plug a leak in a pipe. In this example, the pipe is a 2 inch diameter pipe.

The twist type clamp 710 is fitted with example saddles 720 and 722. In this example, the saddles 720 and 722 have a semi-circular shape that matches the 2 inch of diameter of the pipe 710. Similar to the saddles 120 and 122 in FIG. 1A, the saddles 720 and 722 have a semi-circular main body with an attachment mechanism on the exterior surface and a resilient material adhered to the interior surface. The resilient material is used to contact the exterior of the pipe 710.

In this example, the clamp 710 has an upper arm 730 and a lower arm 732. The upper arm 730 has a general “L” shape while the arm 132 has a general C-shape. The two arms 730 and 732 are rotatably coupled via a pin 734 that allows the rotation of the arms 730 and 732 relative to each other. The arms 730 and 732 have corresponding mandible sections 736 and 738. Similar to the above example, the saddles 720 and 722 may be attached and removed on connector mechanisms on the ends of the mandible sections 736 and 738. In this example, the upper arm 730 has a main support section 740 that is attached to the mandible section 738. The upper arm 730 has two parallel plates 742 and 744 that define the mandible section 738 and the main support section 738. The pin 734 is mounted between the plates 742 and 744 in the main support section 740. An end 746 of the main support section 740 holds a shaft guide 748.

The lower arm 732 includes a main support section 750 that is connected via a connector section 752 to the mandible 738. The sections 738, 750 and 752 are formed by parallel plates 754 and 756. A free end of the main support section 750 is inserted between the plates 742 and 744 of the upper arm 732. The pin 734 is inserted through the plates 754 and 756 at the free end of the main support section 750 to allow the arms 730 and 732 to rotate relative to each other.

A shaft 760 has one end that is attached to the intersection between the main support section 750 and the connector section 752. The shaft 760 has a threaded exterior surface that intermeshes with the interior surface of a hole bored through the shaft guide 748. The opposite end of the shaft 760 is connected to a cylindrical socket 762. A rod 764 is inserted in the socket 762 in perpendicular orientation to the shaft 760.

In this example, the attachment mechanisms of the saddles 720 and 722 are the parallel brackets with a hole similar to those in the saddles 120 and 122 in FIG. 1A. The parallel plates 742 and 744 at the end of the mandible 736 have a hole that may be aligned with the hole in the attachment mechanism of the saddle 720. A pin mechanism 770 holds the saddle 720 to tend of the mandible 736. Similarly, the parallel plates 756 and 756 at the end of the mandible 738 have a hole that allows a pin mechanism 772 to attach the saddle 122 to the mandible 738.

The rod 764 allows a user to apply force to rotate the shaft 760. When the rod 764 and shaft 760 are rotated clockwise, the shaft 762 moves the arm 732 to rotate and thus move the mandible 738 closer to the mandible 736. This causes the saddles 720 and 722 to grip the pipe and thus seal leaks on the surface of the pipe covered by one of the saddles 720 or 722. By turning the rod 764 counter-clockwise, the shaft 760 is rotated counter-clockwise and move the arm 732 in the opposite direction, thus increasing the gap between the saddles 720 and 722 and releasing the pipe.

As explained below, fitting saddles of different diameters allows the clamp 700 to be used to plug leaks in different diameter pipes. FIG. 7B shows a perspective view of the twist type clamp 700 that is fitted with saddles 780 and 782 instead of saddles 720 and 722 to plug a leak in a different diameter pipe. In this example, the pipe is a 3 inch diameter pipe. In this example, the saddles 780 and 782 have a semi-circular shape that matches the 3 inch diameter of the pipe. The operation of the clamp 700 to plug a leak in the 3 inch pipe is described above.

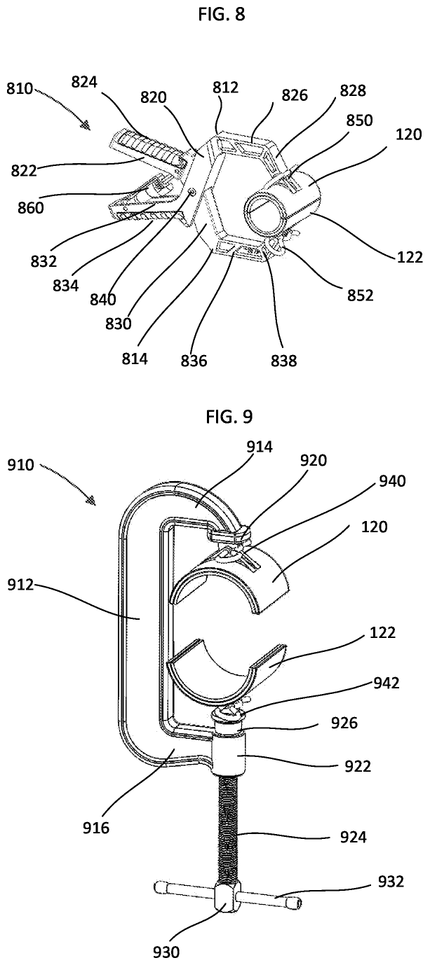

FIG. 8 shows another example how the saddles 120 and 122 may be fit on different types of clamps. FIG. 8 shows a hand clamp 810 that has been fitted with the saddles 120 and 122 for the purposes of patching a leak in a pipe. The hand clamp 810 has two opposing arms 812 and 814. The arm 812 has a main body member 820 with a handle section 822 and an extension section 824. The handle section 822 has a ridged grip section 826. The end of the extension section 824 is attached to a mandible 828. Similarly, the arm 814 has a main body member 830 with a handle section 832 and an extension section 834. The handle section 832 has a ridged grip section 836. The end of the extension section 834 is attached to a mandible 838. The arms 812 and 814 are attached to each via a pin 840 that extends through the main body members 820 and 830. The arms 812 and 814 may be rotated relative to each other via the handle sections 822 and 832.

Each of the mandibles 828 and 838 have a hole that may be aligned with holes on the mounting brackets of the respective saddles 120 and 122. Pins 850 and 852 may be used to attach the saddles 120 and 122 to respective mandibles 828 and 838.

Once the saddles 120 and 122 are attached to the mandibles 828 and 838, the clamp 810 may be used to grip a pipe between the saddles 120 and 122. A user may squeeze the handle sections 822 and 832 together to apply pressure on the pipe through the saddles 120 and 122 thereby plugging a leak. A locking mechanism 860 is located between the handle sections 822 and 832. The locking mechanism 850 applies spring force to keep the handle sections 822 and 832 apart, thus forcing the mandibles 828 and 838 apart. The locking mechanism 850 may be actuated to keep the arms 812 and 814 in place thus locking the clamp 810 on the pipe.

FIG. 9 shows another example how the saddles 120 and 122 may be fit on different types of clamps. FIG. 9 shows a C-clamp 910 that has been fitted with the saddles 120 and 122. The C-clamp 910 has a main body 912 with an upper arm 914 and a lower arm 916. An end 920 of the upper arm 914 holds a fixed attachment bracket that allows attachment of the saddle 120. The lower arm 916 has a cylindrical guide section 922 that holds a shaft 924. One end of the shaft 924 is connected to a clamp holder 926 that includes mechanical features for attachment of the saddle 122. The shaft 924 has a threaded exterior that allows the shaft 924 to engage a threaded interior surface of a hole in the guide section 922. An opposite end 930 of the shaft 924 is connected to a cylindrical socket 930. A rod 932 is inserted in the socket 930 in perpendicular orientation to the shaft 924.

The saddles 120 and 122 matching the diameter of the pipe are installed on the end 920 and the clamp holder 926 via respective pins 940 and 942. After the saddles 120 and 122 are attached, the clamp 910 and the saddle 120 and 122 are positioned around the pipe with the leak. By turning the rod 932 clockwise, the shaft 924 is rotated and moves the clamp holder 926 toward the end 920 of the upper arm 914. Turning the shaft 924 further creates pressure on the pipe between the saddles 120 and 122 to seal the leak.

The example saddles in conjunction with an appropriate clamp is an emergency pipe repair tool for pipes of different materials such as steel, plastic, and copper pipe. The example clamp and saddle tool clamps down on the pipe in order to create a temporary repair to pin hole leaks in the pipe.

The example saddles are applied with different types of clamping devices such as locking pliers. The easy grip closing action of the locking pliers and other clamps is extremely user friendly. The example tool assembly has been tested and it has been determined that the assembly is effective with water leaks up to 250 PSI as well as air leaks to 135 PSI. The example tool allows instant temporary repair to minimize water damage to surrounding products and or machinery from leaking pipes. This allows for piping systems to be kept in use until a permanent repair can be done.

The tool is reusable, and no other tools are required to apply the tool system to plug leaks in pipes. The saddles may be provided in kits with saddles matching different common diameters of pipes. The kit may include the clamp, or the clamp may be available separately. For example, a kit may include saddles for 1 ¼″, 1 ½″, 2″, 2 ½″, 3″ and 4″ diameter plastic pipes allowing use for common diameter plastic pipes. The kit may also include saddles for ½″, ¾″ and 1″ diameter copper pipes allowing use for common copper pipes.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. A clamp saddle for attachment to a pipe clamp, the clamp saddle comprising:
a semi-circular main body that is conformed to a specific pipe diameter; and
an attachment mechanism on the main body that interchangeably connects to an arm of a clamp.

2. The clamp saddle of claim 1, wherein the clamp is one of the group consisting of a C-clamp, a plier clamp, a twist clamp, or a hand clamp.

3. The clamp saddle of claim 1, wherein the clamp further includes another arm that may be connected to another saddle.

4. The clamp saddle of claim 1, further comprising an interior surface layer fabricated from one of nitrile rubber, silicone rubber, or neoprene rubber that engages the pipe surface.

5. The clamp saddle of claim 4, wherein the interior surface layer is attached to the interior surface of the saddle via an adhesive.

6. The clamp saddle of claim 1, wherein the clamp saddle is fabricated from aluminum or steel.

7. The clamp saddle of claim 1, wherein the pipe diameter is one of 0.5 inch, 0.75 inch, 1 inch, 1.25 inches, 1.5 inches, 2 inches, 2.5 inches, 3 inches, or 4 inches.

8. The clamp saddle of claim 1, wherein the pipe is one of plastic pipe, steel pipe, or copper pipe.

9. The clamp saddle of claim 1, wherein the attachment mechanism is a pin mechanism, wherein the saddle includes brackets with a hole aligned to a hole on the arm of the clamp and wherein a shaft of the pin mechanism is inserted in the holes.

10. A clamp for plugging a pipe leak, the clamp comprising:
a first arm having a first end;
a first saddle including a semi-circular main body that is conformed to a specific pipe diameter; and an attachment mechanism on the main body that attaches to the first end of the first arm;
a second arm having a second end; and
a second saddle including a semi-circular main body that is conformed to the specific pipe diameter; and an attachment mechanism on the main body that attaches to the second end of the second arm.

11. The clamp of claim 10, wherein the clamp is one of the group consisting of a C-clamp, a plier clamp, a twist clamp, or a hand clamp.

12. The clamp of claim 10, wherein the first and second saddles each include an interior surface layer fabricated from one of nitrile rubber, silicone rubber, or neoprene rubber that engages the pipe surface.

13. The clamp of claim 12, wherein the interior surface layer is attached to the interior surface of the respective first and second saddles via an adhesive.

14. The clamp of claim 10, wherein the first and second saddle are fabricated from aluminum or steel.

15. The clamp of claim 10, wherein the pipe diameter is one of 0.5 inch, 0.75 inch, 1 inch, 1.25 inches, 1.5 inches, 2 inches, 2.5 inches, 3 inches, or 4 inches.

16. The clamp of claim 10, wherein the pipe is one of plastic pipe, steel pipe, or copper pipe.

17. The clamp of claim 10, wherein the attachment mechanism of the first and second saddles is a pin mechanism, wherein the first and second saddles each include brackets with a hole aligned to a hole on the respective first and second arm, and wherein the pin mechanisms include a respective shaft that may be inserted in the holes.

18. A kit for patching pipes of different diameters, the kit comprising:
a first set of saddles, each of the saddles including a semi-circular main body that is conformed to a specific first pipe diameter; and an attachment mechanism on the main body that attaches to an end of an arm of a clamp; and
a second set of saddles, each of the saddles including a semi-circular main body that is conformed to a specific second pipe diameter; and an attachment mechanism on the main body that attaches to the end of the arm of the clamp.

19. The kit of claim 18, wherein the first and second diameters include one of 0.5 inch, 0.75 inch, 1 inch, 1.25 inches, 1.5 inches, 2 inches, 2.5 inches, 3 inches, or 4 inches.

20. The kit of claim 18, further comprising a clamp having a first and a second arm, wherein each of the first set of saddles and each of second set of saddles are attachable to the first and the second arm of the clamp.
